(19) United States
(12) Patent Application Publication
(10) Pub. No.: US 2023/0059198 A1
(43) Pub. Date: Feb. 23, 2023

(54) BASE STATION, INFORMATION PROCESSING DEVICE, WIRELESS COMMUNICATION METHOD, AND PROGRAM

(71) Applicant: Panasonic Holdings Corporation, Osaka (JP)

(72) Inventors: Yuzo MORIUCHI, Mie (JP); Rei HASEGAWA, Osaka (JP)

(21) Appl. No.: 17/758,642

(22) PCT Filed: Jan. 14, 2021
(86) PCT No.: PCT/JP2021/000945

§ 371 Date: Jul. 12, 2022

(30) Foreign Application Priority Data
Jan. 17, 2020 (JP) 2020-006160

(51) Int. Cl. H04W 16/28; H04W 52/26

(52) U.S. Cl. CPC H04W 16/28; H04W 52/26

(57) ABSTRACT

The present invention contributes to providing a base station, an information processing device, a wireless communication method, and a program, with which it is possible to realize control considering power leaked outside a given area. The base station comprises: a control circuit that controls a beam formed in an indoor area, on the basis of a simulation result relating to a wireless propagation environment that includes propagation of radio waves from inside the indoor area to outside; and a communication circuit that communicates with a wireless instrument using the beam.

### TECHNICAL FIELD

The present disclosure relates to a base station, an information processing apparatus, a radio communication method, and a program.

### BACKGROUND ART

When a radio communication system is constructed in a specific area, placement of a radio base station is determined such that the communication quality in the specific area satisfies a desired quality.

### CITATION LIST

### Patent Literature

### PTL 1

Japanese Patent Application Laid-Open No. 2019-198055

### SUMMARY OF INVENTION

However, there is scope for further study on an influence (e.g., interference) of radio waves leaking outside the specific area (e.g., leakage power) on other radio communications.

One non-limiting exemplary embodiment of the present disclosure facilitates providing a base station, an information processing apparatus, a radio communication method, and a program capable of achieving control in consideration of leakage power to the outside of a certain area.

A base station according to one exemplary embodiment of the present disclosure includes: control circuitry, which, in operation, controls a beam based on a simulation result regarding a radio propagation environment including radio wave propagation from an inside of an indoor area to an outside of the indoor area, the beam being to be formed in the indoor area; and communication circuitry, which, in operation, communicates with a radio device using the beam.

An information processing apparatus according to one exemplary embodiment of the present disclosure includes: a determiner, which, in operation, determines information on a beam to be formed by a base station in an indoor area where the base station is installed, the determining being based on a simulation result regarding a radio propagation environment including radio wave propagation from an inside of the indoor area to an outside of the indoor area; and an output, which, in operation, outputs the determined information on the beam.

A radio communication method according to an exemplary embodiment of the present disclosure includes steps performed by a base station of: controlling a beam based on a simulation result regarding a radio propagation environment including radio wave propagation from an inside of an indoor area to an outside of the indoor area, the beam being to be formed in the indoor area; and communicating with a radio device using the beam.

A program according to an exemplary embodiment of the present disclosure causes a computer to execute processing of: determining a beam to be formed by a base station in an indoor area where the base station is installed, the determining being based on a simulation result regarding a radio propagation environment including radio wave propagation from an inside of the indoor area to an outside of the indoor area; and outputting information on the beam determined.

It should be noted that general or specific embodiments may be implemented as a system, an apparatus, a method, an integrated circuit, a computer program, a storage medium, or any selective combination thereof.

According to an exemplary embodiment of the present disclosure, it is possible to achieve control in consideration of leakage power to the periphery of a certain area.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates one example of base station placement in an indoor area and a radio wave reach range of a base station;

FIG. 2 illustrates one example of the base station placement and the radio wave reach range of the base station in an embodiment;

FIG. 3 illustrates one example of an information processing apparatus according to the embodiment;

FIG. 4 illustrates one example of a configuration of the base station according to the embodiment;

FIG. 5 illustrates one example of beam patterns at maximum transmission power and beam patterns at limited transmission power according to the embodiment;

FIG. 6A illustrates an exemplary propagation characteristic (attenuation characteristic) of a signal transmitted with a beam at maximum transmission power Pbmax according to the embodiment;

FIG. 6B illustrates one example of a propagation characteristic of FIG. 6A in a case where a building transmission loss occurs at a building boundary;

FIG. 6C illustrates one example of a propagation characteristic of FIG. 6B in a case where the transmission is performed at limited transmission power;

FIG. 7A illustrates one example of beam selection by the base station according to the embodiment;

FIG. 7B illustrates one example of beam selection by the base station according to the embodiment;

FIG. 8A illustrates one example of transmission power control for a terminal in the embodiment;

FIG. 8B illustrates one example of transmission power control for the terminal in the embodiment;

FIG. 9 illustrates another example of a service area in the embodiment;

FIG. 10 illustrates yet another example of the service area in the embodiment;

FIG. 11 illustrates still another example of the service area in the embodiment;

FIG. 12 illustrates even another example of the service area in the embodiment;

FIG. 13 illustrates still even another example of the service area in the embodiment;

FIG. 14 illustrates one example in which a plurality of base stations are placed in the embodiment; and

FIG. 15 illustrates one example of directivity control in the embodiment.

### DESCRIPTION OF EMBODIMENTS

Hereinafter, preferred embodiments of the present disclosure will be described in detail with reference to the appended drawings. Note that, in the present specification and drawings, components having substantially the same functions are provided with the same reference symbols, and redundant description will be omitted.

### One Embodiment

In a cell design of a base station, placement of the base station of a radio communication system for providing a radio communication service in a certain area is determined based on the transmission capability of the base station and information (spatial information) on the structure of the area. The area in which the radio communication system provides the radio communication service may be described as a “service area,” for convenience. For example, the service area may be referred to as a “service space” or a “service area space.”

Autonomous control of the base station placed (and/or coordinated control by a plurality of base stations) is performed based on device training and/or a report on radio communication quality from a terminal (user equipment (UE)). For example, the base station adjusts the transmission power and/or reception power based on a measurement result of an interference level of interference with another base station covering an adjacent area (“interference level measurement”), and/or a report (“quality report”) on radio communication quality reported from the terminal, etc.

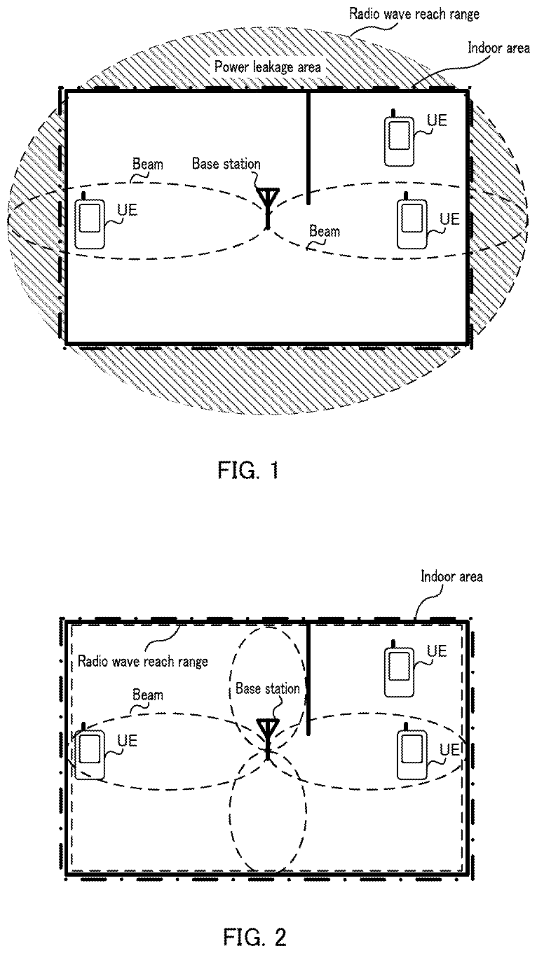

FIG. 1 illustrates one example of the base station placement and the radio wave reach range of the base station in the indoor area. FIG. 1 illustrates the base station located in the indoor area that is one example of the service area, UEs located in the indoor area, and the radio wave reach range of the base station formed by beams in multiple directions. The radio wave reach range is one example of a range reached by radio waves radiated by the base station at a level equal to or higher than a predetermined level, and may be referred to as a coverage area of the base station. The radio wave reach range may be different from the service area.

Note that, the indoor area in FIG. 1 is a certain indoor room, and the outer periphery of the indoor area corresponds to, for example, a wall surface of the room. Further, in FIG. 1 illustrates the indoor area seen from above in plan view, but the indoor area may be defined as a three-dimensional space including the height direction.

For example, in case that placement of the base station is determined based on the transmission capability of the base station, it may happen that the radio wave reach range is larger than the indoor area. In this case, a radio wave emitted by the base station reaches the outside of the indoor area. For example, the area represented by the diagonal lines in FIG. 1 is an area outside the indoor area where the radio wave radiated from the base station reaches (hereinafter sometimes referred to as “power leakage area”). For example, when another radio system (e.g., a primary system) is operated in the power leakage area, radio wave interference is given to the other radio system.

For example, one or more base stations within the service area are capable of controlling communication within the service area using interference level measurements and quality reports within the service area. However, since these measurement results and quality reports do not indicate the radio environment outside the service area, it is difficult for the base station to confirm (or estimate) how much leakage power occurs outside the service area. Therefore, for example, a control for suppressing the leakage power to the outside of the service area is difficult.

As one method of confirming or estimating the radio environment outside the service area, disposing a sensor or the like for detecting the leakage power in the area outside the service area (e.g., in the power leakage area in FIG. 1) may be assumed, for example. In this case, it may be assumed that the base station performs a control of suppressing the leakage power using the detection result of the sensor. However, introduction of equipment including the sensor, placement of the sensor, and provision of a means for obtaining information from the sensor separately from the base station enlarge the radio system as a whole.

Also, in case that a radio system (for example, sometimes referred to as a secondary system) constructed in the service area is different from the primary system, it may be necessary, for example, to add an interface for transmitting and receiving sensor information between the systems.

In the present embodiment, by the base station controlling the transmission power (e.g., beam control) by using information determined in advance based on the information on the structure of the service area, it is made possible to conduct such a control as to suppress the power leakage to the outside of the service area.

FIG. 2 illustrates one example of the base station placement and the radio wave reach range of the base station in the present embodiment. In FIG. 2 as in FIG. 1, the base station disposed in the indoor area, UEs located in the service area, and the radio wave reach range of the base station are illustrated.

In FIG. 2, as compared to FIG. 1, the power of beams formed by the base station differs depending the directivities of the beams. In the present embodiment, the base station controls the power for each beam based on the information on the structure of the service area. Such a beam power control can control the shape of the radio wave reach range by the base station, and for example, can suppress or minimize the leakage power to a specific direction toward the outside of the service area.

Hereinbelow, the beam control by the base station illustrated in FIG. 2 will be described. For example, the beam control is performed based on a result of a radio wave propagation simulation. The radio wave propagation simulation is performed, for example, by an information processing apparatus described below.

<Configuration Example of Information Processing Apparatus>

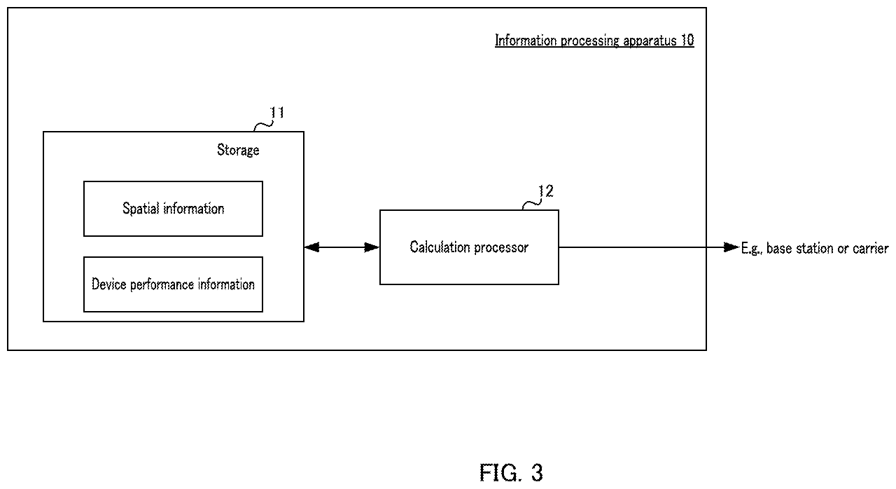

FIG. 3 illustrates one example of information processing apparatus 10 according to the present embodiment. Information processing apparatus 10 determines, for example, the installation position of the base station in the service area. In addition, information processing apparatus 10, for example, determines information relating to the beam control in accordance with the radio wave propagation simulation.

Information processing apparatus 10 includes, for example, storage 11 and calculation processor 12.

Storage 11 stores, for example, spatial information and device performance information.

The spatial information may include, for example, information regarding the structure of the service area in which the base station is installed. The information on the structure of the service area may include, for example, the size of the service area, i.e., the dimensions of the space. For example, in case that the service area is the indoor area partitioned by a wall or the like, the information on the structure of the service area may include information on fixed objects such as walls, windows, partitions, etc. The information on the objects may include, for example, at least one information on the positions, sizes, and materials of the objects. The information on the materials may include, for example, at least one of the reflectance, transmittance, diffusivity, scattering rate, conductivity, dielectric constant, and the like of the radio wave.

The spatial information may also include information on the installation position of the base station determined by information processing apparatus 10. Also, for example, the spatial information may include information on at least one of the position of an antenna of the base station and information on the orientation (angle) of the antenna.

Further, the spatial information may include, for example, information on a radio system operated outside the service area. For example, the spatial information may include a limit value of the leakage power leaking outside the service area (sometimes referred to as “allowable leakage power”).

The device performance information may include, for example, information on the radio characteristics of the base station (e.g., at least one of maximum transmission power, number of beams, beam width, and the like).

Calculation processor (determiner) 12 determines the installation position of the base station, for example, based on the spatial information and the device performance information. For example, calculation processor 12 calculates the power distribution in the service area by the radio wave propagation simulation based on the spatial information (e.g., information on the structure of the service area) and the maximum transmission power of the base station. Ray tracing or a Finite-difference time-domain (FDTD) method, for example, may be used in the radio wave propagation simulation. Then, with reference to the power distribution, calculation processor 12 determines, as the installation position of the base station, a position making it possible to secure expected communication quality in the service area. The information on the determined installation position may be stored in storage 11, for example.

The information on the installation position determined by calculation processor 12 is outputted by information processing apparatus 10, and notified to the base station or a carrier who installs the base station. The business operator who installs the base station installs the base station based on the notified information, for example.

Further, calculation processor 12 determines, for example, information relating to the beam control (hereinafter, sometimes referred to as “beam control information”) by simulation. The beam control information may include, for example, a weighting factor (Antenna Weight Vector (AWV)) that configures the beam direction and beam power. The beam control information may also include, for example, a correspondence between positions in the service area and one or more beams. The method of determining the beam control information will be described later.

Further, calculation processor 12 may calculate the effective utilization degree (beam utilization efficiency) of resources and the power efficiency of the base station. For example, calculation processor 12 may calculate a combination of beams improving communication quality in the service area. The result calculated in calculation processor 12 may be included in the beam control information.

Information processing apparatus 10 outputs a part of the information stored in storage 11 to a below-described base station. Further, information processing apparatus 10 outputs the beam control information determined by calculation processor 12 to the base station.

<Configuration Example of Base Station>

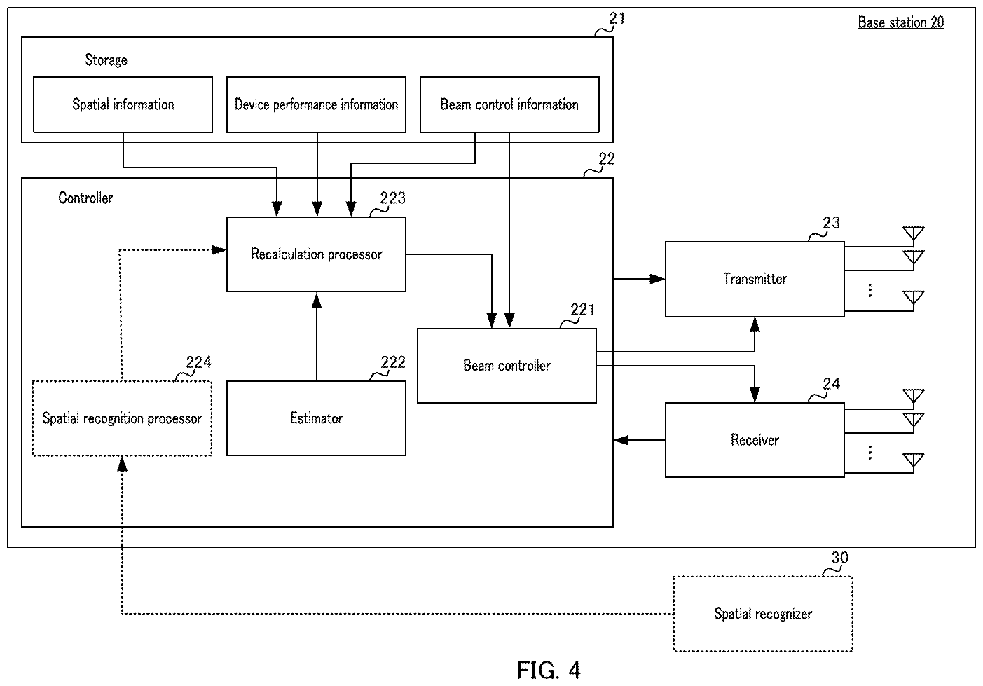

FIG. 4 illustrates one example of the configuration of base station 20 according to the present embodiment. Base station 20 includes storage 21, controller 22, transmitter 23, and receiver 24. Transmitter 23 and receiver 24 may be referred to as a communicator.

Storage 21 stores the information outputted by information processing apparatus 10. For example, storage 21 stores the spatial information, device performance information, and beam control information. The spatial information stored in storage 21 may be the same as the spatial information stored in storage 11 of information processing apparatus 10 described above, or may be information different from the spatial information stored in storage 11 of information processing apparatus 10 (for example, the spatial information stored in storage 11 of information processing apparatus 10 from which a part of the information is omitted (reduced)). The device performance information stored in storage 21 may be the same as the device performance information stored in storage 11 of information processing apparatus 10 described above, or may be information different from the device performance information stored in storage 11 of information processing apparatus 10 (e.g., the device performance information stored in storage 11 of information processing apparatus 10 from which a part of the information is omitted).

Controller 22 controls signal transmission by transmitter 23 of base station 20. Controller 22 outputs, to transmitter 23, a transmission signal addressed to UE and configures a beam used for signal transmission addressed to the UE. Further, controller 22 controls signal reception by receiver 24 of base station 20. For example, controller 22 configures a beam used for signal reception (e.g., directivity of reception), and obtains, from receiver 24, the signal received by the beam.

Transmitter 23, for example, includes a plurality of antenna elements, and performs weighting on the antenna elements to form a beam (e.g., main lobe) in a specific direction corresponding to the weighting. Transmitter 23 transmits a transmission signal addressed to the UE under the control of controller 22. For example, transmitter 23 performs encoding and modulation on the transmission signal addressed to the UE to generate a baseband signal. Transmitter 23 performs frequency conversion on the baseband signal (e.g., up-conversion). Further, transmitter 23, for example, forms a beam in a direction corresponding to the weighting configured by controller 22, and transmits the transmission signal using the formed beam.

Receiver 24 includes a plurality of antenna elements, and performs weighting on the antenna elements to form a beam (e.g., a main lobe) in a specific direction. Receiver 24 receives a reception signal from the UE under the control of controller 22. For example, receiver 24 forms a beam in a direction corresponding to the weighting configured by controller 22 to receive the reception signal using the formed beam. Receiver 24 performs frequency conversion on the reception signal (e.g., down-conversion) to generate a baseband signal. Receiver 24, for example, performs demodulation and decoding on the baseband signal to restore the signal transmitted by the UE, and outputs the restored signal to controller 22. The reception signal from the UE may include, for example, a report (quality report) on reception quality measured by the UE.

Controller 22 includes, for example, beam controller 221, estimator 222, and recalculation processor (determiner) 223.

Beam controller 221 controls beam formation in at least one of transmitter 23 and receiver 24 based on the beam control information. For example, beam controller 221 configures at least one of transmitter 23 and receiver 24 with the weighting factors (AWVs) corresponding to one or more beams used for communication between base station 20 and the UE.

Estimator 222 estimates the position of the UE based on, for example, the quality report included in the reception signal from the UE. For example, the quality report includes information on the reception quality of the signal received by the UE. Estimator 222 determines information on the beam suitable for reception by the UE (hereinafter, sometimes referred to as “UE selected beam information”), for example, based on the quality report received from the UE. Estimator 222 outputs the determined UE selected beam information to recalculation processor 223. Estimator 222 may output the information on the estimated UE position to recalculation processor 223.

Note that the position of the UE may be estimated by another external location system (e.g., Bluetooth (BT) (registered trademark) beacon). In this case, estimator 222 may obtain the information on the position of the UE from the location system.

Recalculation processor 223 updates (corrects) the beam control information using the spatial information and the device performance information in storage 21 and the output of estimator 222. For example, recalculation processor 223 controls, based on the information on the position of the UE, the beam used for communication with the UE.

Further, regarding the combination of beams included in the beam control information, recalculation processor 223 may determine the priorities of combinations of beams using machine learning (or artificial intelligence (AI)) based on the result of communication performed using the combinations of beams.

Note that, the beam control at base station 20, for example, may be performed based on a detection (or recognition) result of detection of an object affecting the radio wave propagation in the service area. For example, as illustrated by a dotted line in FIG. 4, base station 20 may be connected to spatial recognizer 30 by wire or by radio, and controller 22 may perform the beam control based on an output of spatial recognizer 30. In this case, controller 22 may include spatial recognition processor 224.

Spatial recognizer 30 detects, for example, a change in the radio environment in the service area. For example, at least one of an optical radar, a radio radar, a camera, a sensor, and radio detection (retro-directive) may be applied as spatial recognizer 30. Spatial recognizer 30 detects a change in the radio environment, such as movement of a person or a movable object (e.g., a whiteboard) in the service area.

Spatial recognizer 30 may include an interface for receiving information from a device or a system disposed in the service area. The interface may receive the information from the device or system such as, for example, a monitoring camera, a sensor for detecting a person for automatically controlling a door, a sensor for detecting opening and closing of a window, and a system for detecting the presence of a person that are disposed in the service area.

Spatial recognition processor 224 of controller 22, for example, receives the information outputted by spatial recognizer 30. Spatial recognition processor 224 may, for example, detect a change in the radio environment in the service area and output the detected information to recalculation processor 223.

In this case, recalculation processor 223 controls the beam used for communication, depending on the change in the radio environment in the service area. For example, in case that a door existing in the service area is opened, the power leaking outward from the door is greater than in the case where the door is closed. Therefore, recalculation processor 223, for example, adjusts the weighting factor (AWV) of the beam to control the power of the beam that is to travel toward the direction in which the door is located, such that the leakage power to the outside of the door is suppressed to or below the allowable leakage power. For example, when it is detected that an obstacle exists in the direction of the beam used for communication with a certain UE, recalculation processor 223 may instruct beam controller 221 to change the direction of the beam used for communication with the UE to another direction.

Spatial recognizer 30 may be included in base station 20, for example. Spatial recognition processor 224 of controller 22 may be provided inside spatial recognizer 30, or may be included in an external apparatus that is connected to base station 20 and is different from spatial recognizer 30.

The above-described configuration of base station 20 (a plurality of functional units of base station 20) may be divided (or separated) into a plurality of physical or logical units (or blocks). For example, the configuration of base station 20 may be divided into a first unit including storage 21 and recalculation processor 223, and a second unit including beam controller 221, estimator 222, transmitter 23, and receiver 24. The first unit may be referred to as a Distributed Unit (DU) or a Central Unit (CU), for example. The second unit may be referred to as a Remote Unit or a Radio Unit (RU), for example. The plurality of functional units included in base station 20 may also be divided into, for example, three functional units: CU, DU, and RU. The DU or RU may correspond to the “base station” installed in the indoor area.

<One Example of Determination of Beam Control Information>

Next, the beam control information obtained in information processing apparatus 10 will be described. For example, calculation processor 12 of information processing apparatus 10 conducts a simulation (radio wave propagation simulation) relevant to the radio propagation environment including radio wave propagation to the outside from the inside of the indoor service area. Controller 22 of base station 20 controls the beam in the indoor service area based on the result of the simulation (e.g., beam control information).

For example, calculation processor 12 conducts the radio wave propagation simulation using the performance of transmitter 23 of base station 20, the characteristics of the antenna beam, the ID of the antenna beam and its reference direction, the installation location of base station 20 (e.g., three-dimensional coordinates represented by (X, Y, Z)), the installation conditions of base station 20 (e.g., the orientation of the antenna (azimuth and depression angles)), spatial information, and the allowable leakage power (Pth).

For example, calculation processor 12 determines, by simulation of the radio wave propagation, the radio wave propagation characteristics in a case where the base station installed in the service area performs transmission at the maximum transmission power (Pbmax).

Then, calculation processor 12 calculates the leakage power of each beam using the calculated radio wave propagation characteristics. For example, the leakage power of beam #m is expressed as Pc(m).

Then, calculation processor 12 calculates, for each beam, the limited transmission power for limiting the leakage power to or below the allowable leakage power. For example, limited transmission power Pb(m)max of beam #m is calculated using the relation Pb(m)max=Pbmax−Pc(m).

Then, calculation processor 12 determines the configuration value of the AWV making the transmission power of each beam the limited transmission power.

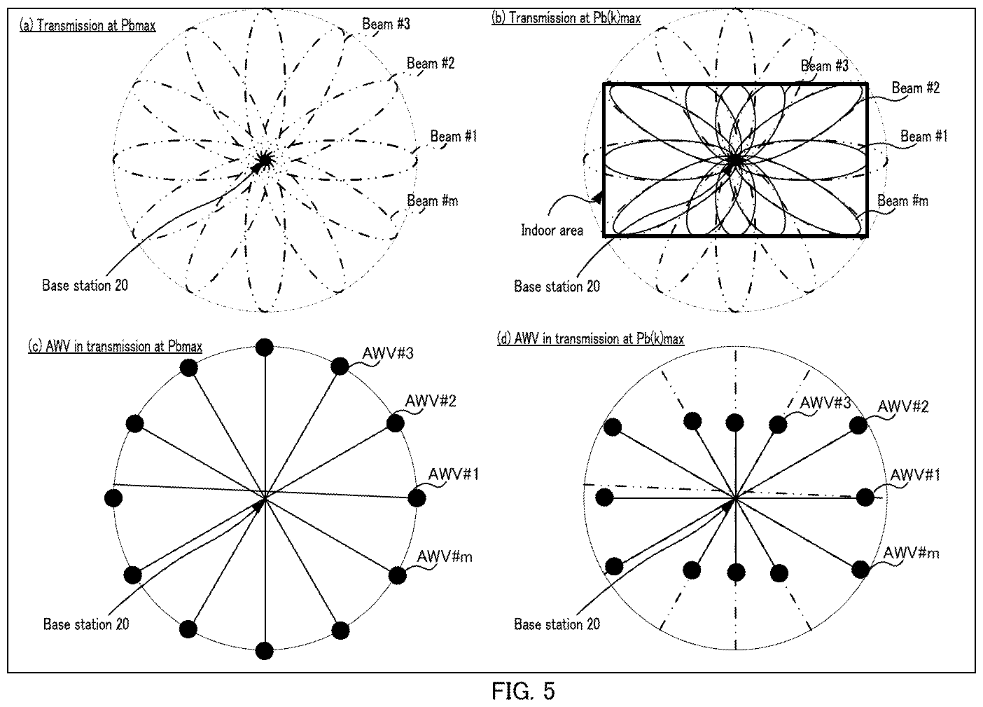

FIG. 5 illustrates one example of beam patterns at the maximum transmission power and beam patterns at the limited transmission power.

At (a) in FIG. 5, exemplary beam patterns of beam #1 to beam #m transmitted at maximum transmission power Pbmax are illustrated. Also illustrated at (b) in FIG. 5 are exemplary beam patterns of beam #1 to beam #m when transmission is performed at limited transmission power Pb(k)max (“k” denotes an integer of any of 1 to m) determined in consideration of the leakage power.

At (c) in FIG. 5, the AWVs corresponding to (a) in FIG. 5 are illustrated, and at (d) in FIG. 5, the AWVs corresponding to (b) in FIG. 5 are illustrated.

Base station 20 achieves, for example, the beam patterns at the limited transmission power as illustrated at (b) in FIG. 5, by performing the beam control using the configuration values of the AWVs determined by calculation processor 12.

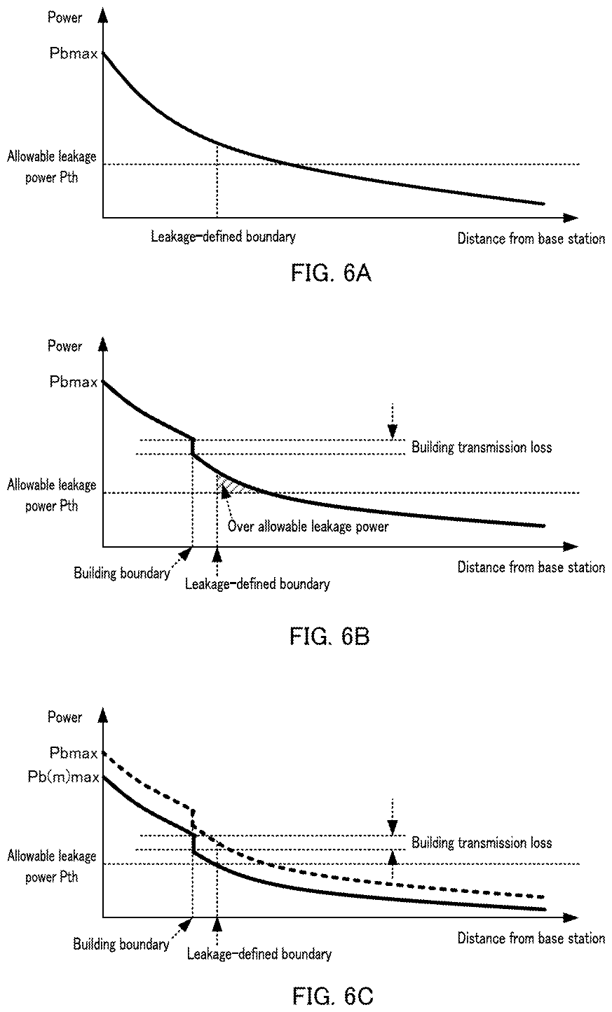

FIG. 6A illustrates an exemplary propagation characteristic (attenuation characteristic) of a signal transmitted with a beam at maximum transmission power Pbmax. The horizontal axis in FIG. 6A illustrates the distance from the base station, and the vertical axis illustrates the power. Also illustrated in FIG. 6A are the allowable leakage power and a leakage-defined boundary. The leakage-defined boundary may be a boundary between the service area and the outside of the service area.

FIG. 6B illustrates one example of the propagation characteristics of FIG. 6A in a case where a building transmission loss occurs at a building boundary.

The example of FIG. 6B illustrates the power exceeding the allowable leakage power that leaks outside the leakage-defined boundary.

Calculation processor 12 determines, for each beam, the limited transmission power at which the power leaking outside of the leakage-defined boundary can be suppressed to or below the allowable leakage power.

FIG. 6C illustrates one example of the propagation characteristics of FIG. 6B in a case where the transmission is performed at the limited transmission power. In FIG. 6C, as one example, the propagation characteristics of beam #m at limited transmission power Pb(m)max are illustrated.

As illustrated in FIG. 6C, in the case of transmission at the limited transmission power, the power leaking outside the leakage-defined boundary falls on or below the allowable leakage power.

Note that, the distance from base station 20 to the leakage-defined boundary may be different between beam directions. Therefore, calculation processor 12 determines, for each beam, the limited transmission power such that the power leaking outward from the leakage-defined boundary falls on or below the allowable leakage power.

Information processing apparatus 10 determines the AWV corresponding to the limited transmission power for each beam and outputs the beam control information including the AWV. Base station 20 performs the beam control based on the beam control information.

For example, base station 20 performs a beam sweep and transmits a synchronization signal for radio connection with the UE. Here, the beam used for transmission of the synchronization signal is configured based on the beam control information. The synchronization signal may include an identifier (beam ID) of the beam used.

Upon receiving the synchronization signal, the UE transmits the quality report to base station 20. The quality report includes, for example, the beam ID of the beam selected in the UE and the quality of the received synchronization signal (e.g., Received Signal Strength Indicator (RSSI)). Note that the quality of the received synchronization signal may be represented in a format different from that of the RSSI. For example, the quality of the received synchronization signal may be represented by a Signal to Noise Ratio (SNR), or Signal to Interference and Noise Ratio (SINR).

Base station 20 selects a beam to be used for communication with the UE based on the quality report. For example, base station 20 selects the beam with the beam ID included in the quality report. Then, base station 20 transmits and receives signals to and from the UE using the selected beam.

Note that, base station 20 may select a beam different from that with the beam ID included in the quality report. For example, base station 20 may use the information obtained from the simulation result of simulation by information processing apparatus 10 to determine the beam to be used for communication with the UE. Hereinafter, an example of beam selection in base station 20 will be described.

<Example of Beam Selection by Base Station>

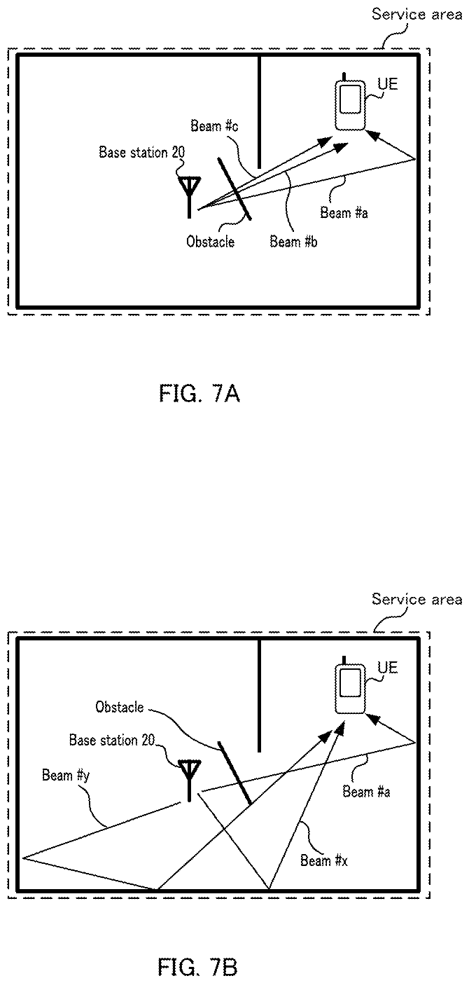

FIGS. 7A and 7B illustrate examples of beam selection by base station 20 according to the present embodiment.

FIG. 7A illustrates exemplary beam directions from base station 20 in a case where beam selection is made based on the quality report from the UE.

In the example of FIG. 7A, because the direction of beam #a, the direction of beam #b, and the direction of beam #c selected based on the quality report from the UE are spatially close to one another (spatial correlation (space correlation) is high), the beams in the three directions are likely to be blocked together by an obstacle. In other words, in the example of FIG. 7A, the communication is vulnerable to blockage by an obstacle.

Also, in the example of FIG. 7A, depending on the model of the UE and/or UE specific characteristics, it may happen that training for determining beams (e.g., training referred to as BFT) does not converge.

In the present embodiment, since base station 20 performs the beam control based on the result of the radio wave propagation simulation, the beam control does not have to be based on the quality report received from the UE. In other words, controller 22 of base station 20 may perform the beam control (e.g., determination of the beam used for communication) without basing the beam control on the quality report. Not basing the beam control on the quality report may correspond to not handling the quality report effectively or ignoring (disabling) the quality report. However, the beam control may be performed based on both the simulation result and the quality report.

FIG. 7B illustrates one example of beam determination in the present embodiment.

Base station 20 has the correspondence between the position (e.g., three-dimensional coordinates) within the service area and one or more beams suitable for communication with the UE present at that position. This correspondence, for example, is determined in advance by the radio wave propagation simulation in information processing apparatus 10, and may be represented in a table format. Hereinafter, this table of the correspondence will be referred to as “beam selection table,” for convenience. The beam selection table may, for example, be included in the beam control information and stored in storage 21.

For example, the beam selection table may be determined based on the conditions configured in the radio wave propagation simulation. For example, the most significant beam or the most significant N beams (“N” denotes an integer greater than or equal to 2) may be associated with one position in the service area. Alternatively, a plurality of beams based on spatial correlation may be associated with one position in the service area.

Based on the positional information of the UE and beam selection table, base station 20 determines to use, for communication with the UE, one or more beams associated with the position of the UE. For example, the UE positional information may be received by base station 20 from the UE. Alternatively, the UE positional information may be estimated by base station 20 based on a signal received from the UE.

In FIG. 7B, base station 20 selects beam #a, beam #x, and beam #y based on the UE positional information.

Since this beam selection is not based on the quality report from the UE, base station 20 can use an appropriate beam for communication even in a case where the quality report from the UE is erroneous due to a variation in strength per beam (e.g., reception level at the UE). The case where the quality report from the UE is erroneous is, in other words, a case where the accuracy (reliability) of the quality report from the UE is low. The case where the quality report from the UE is erroneous may include, for example, a case where the beam selected by the UE is different from an optimal beam.

For example, in next-generation radio communication, referred to as 5G (5th Generation), a radio communication apparatus (e.g., a base station) may determine, from among a number of possible beams (e.g., 256 beams), a plurality of beams (e.g., eight beams) to be used in communication. In such a case, the number of combinations of beams used for communication increases. In the present embodiment, since base station 20 can perform the beam selection using the correspondence obtained in advance, an appropriate beam can be selected even when the number of combinations of beams increases.

Further, such beam selection makes it possible to use spatially distant beams for communication. It is thus possible to improve the resistance (robustness) to communication disconnection due to blockage by an obstacle in the service area.

In addition, the beam selection makes it possible to reduce the probability that training for determining the beam (e.g., training referred to as BFT) does not converge.

Note that, base station 20 may change the beam determined based on the UE positional information and the beam selection table to another beam (beam in another direction) based on the quality report from the UE. For example, the case where communication is interrupted by a movable object such as a person is not considered in the radio wave propagation simulation. In such a case, the beam determined based on the quality report from the UE may be more suitable for communications than the beam determined using the beam selection table. Therefore, the base station may change the beam determined based on the UE positional information and the beam selection table to a beam determined based on the quality report.

Base station 20 may control the transmission power of the UE when using a beam whose power is limited based on the beam control information. Hereinafter, an example of transmission power control for a UE will be described.

<One Example of Transmission Power Control for UE>

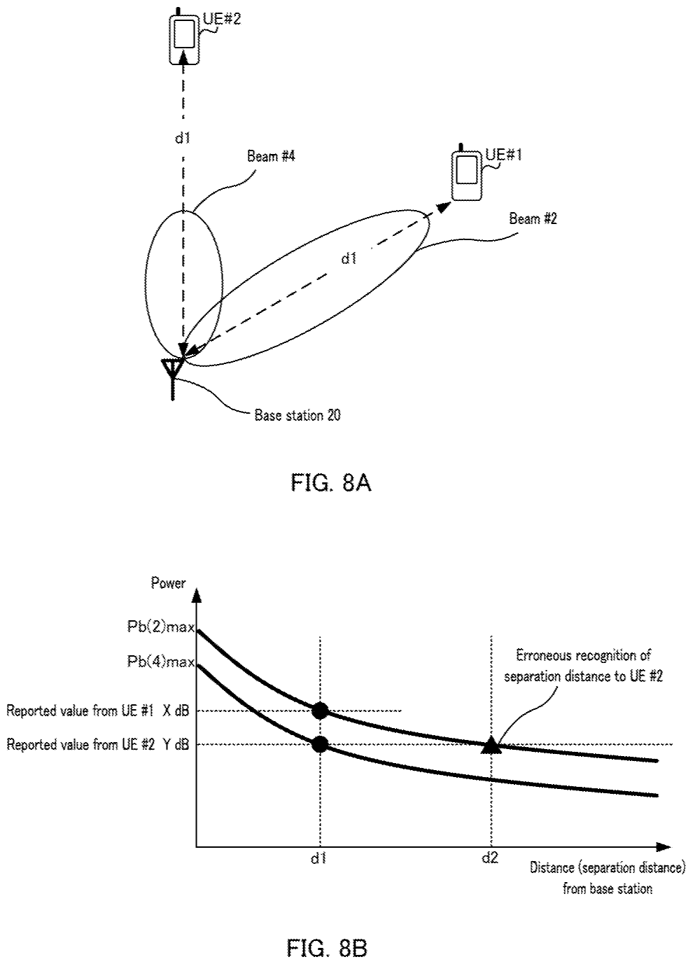

FIGS. 8A and 8B illustrate one example of transmission power control for a UE in the present embodiment.

In FIG. 8A, UE #1 located in the direction of beam #2 formed by base station 20 and UE #2 located in the direction of beam #4 are illustrated. Note that, beam #2 and beam #4 illustrated in FIG. 8A are beams with respective different limited transmission powers, for example, as illustrated in FIG. 5. The distance between base station 20 and UE #1 and the distance between base station 20 and UE #2 are d1.

The vertical axis in FIG. 8B illustrates the power (or RSSI), and the horizontal axis illustrates the separation distance from base station 20. In addition, Pb(2)max in FIG. 8B denotes the transmission power of beam #2 illustrated in FIG. 8A, and Pb(4)max denotes the transmission power of beam #4.

Here, since the transmission power of beam #2 is greater than the transmission power of beam #4, RSSI (e.g., X [dB] in FIG. 8B) in the quality report reported from UE #1 is greater than RSSI (e.g., Y [dB] in FIG. 8B) in the quality report reported from UE #2. In this case, when base station 20 assumes that the transmission powers of the beams are the same (for example, the transmission power of beam #4 is the same as Pb(2)max), it is determined that UE #2 is located at a greater distance (for example, d2 (d2>d1)) than UE #1 is, as indicated by a triangular point in FIG. 8B. In this case, base station 20 may instruct UE #2 to perform transmission at a transmission power (e.g., P (UE #2)) greater than the transmission power (e.g., P (UE #1)) of UE #1. For example, in case that UE #2 transmits a signal using P (UE #2) in spite of the distance of d1 from base station 20, UE #2 may consume excessive transmission power.

Therefore, in the present embodiment, for example, RSSI is corrected (e.g., weighted) based on the AWV corresponding to the selected beam. For example, in the example of FIGS. 8A and 8B, RSSI reported by UE #2 is weighted based on the AWV corresponding to beam #2, and RSSI reported by UE #1 is weighted based on the AWV corresponding to beam #4. The AWV corresponding to each beam may be included in the beam control information described above.

Base station 20 uses the weighting results to control the beam transmission power for each UE depending on the distance to each of the UEs. In other words, for example, controller 22 of base station 20 corrects, based on the result of the radio wave propagation simulation, the transmission power of the UE that is based on the quality report received from the UE. This will enable each of the UEs to perform communication with the necessary and sufficient power that can ensure communication quality, thereby suppressing the power consumption of the UE. Further, the increase in interference can be avoided, because the signal transmission with the excess power can be avoided.

As described above, based on the beam control information determined by information processing apparatus 10 by the radio wave propagation simulation, base station 20 controls the beam used for radio communication with the UE. The beam control information includes information on the beam control (e.g., AWV) corresponding to the limited transmission power at which the power leaking outside the service area can be suppressed to or below the allowable leakage power. Thus, it is possible to achieve the control considering the leakage power to the periphery, so as to suppress the interference with the radio system operated outside the service area. Thus, base station 20 can ensure the communication quality with the necessary and sufficient power, to suppress the power consumption of base station 20.

According to the present embodiment, base station 20 can select a beam suitable for a radio communication link with a UE, and can establish a stable radio communication link independently of the accuracy (reliability) of the quality report from the UE.

Further, according to the present embodiment, base station 20 can select a beam based on the spatial recognition of the service area to ensure the communication quality adapted to the spatial change.

Note that, the above-described embodiment has been described in connection with the example in which the service area is an indoor room, but the present disclosure is not limited thereto. For example, the service area may be defined outdoors.

Further, the above embodiment has been described in connection with the example in which the service area is regarded as a plane, in other words, the example in which the boundary between the service area and the outside of the service area is defined in the X-Y plane, but the present disclosure is not limited thereto. For example, the service area may be defined in a three-dimensional space. Hereinafter, a variation of the service area defined in the three-dimensional space will be described.

<Variation of Service Area>

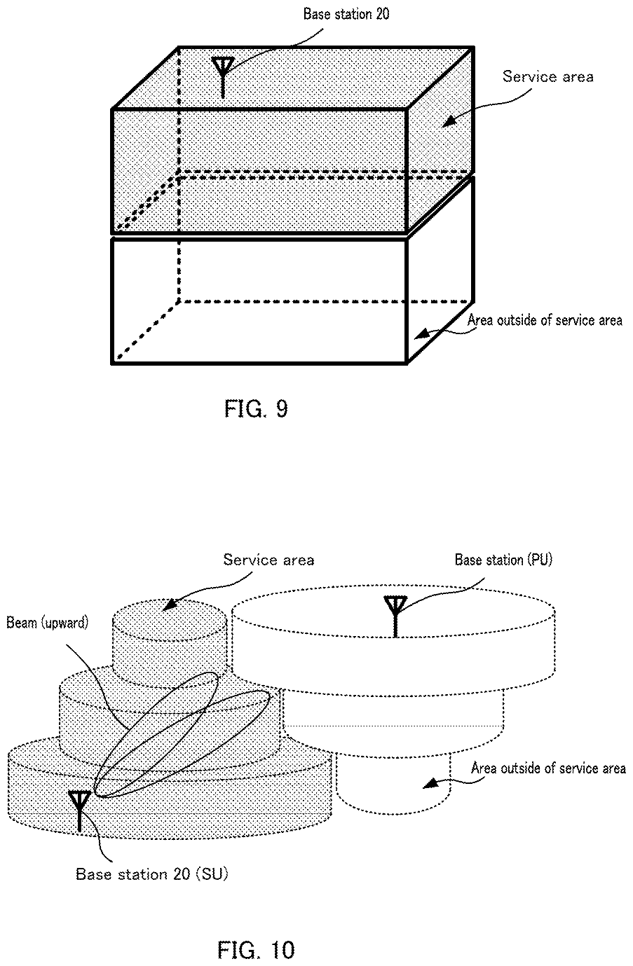

FIG. 9 illustrates another example of the service area in the present embodiment. As illustrated in FIG. 9, one story (upper story in FIG. 9) of a multistory building may be defined as the service area, and another story (lower story in FIG. 9) may be defined as the outside of the service area.

In this case, base station 20 determines AWVs suppressing, to or below the allowable leakage powers, the powers of beams directed in multiple directions in the three-dimensional space which leak to an area outside the service area.

When base station 20 disposed in the service area corresponds to a base station of a secondary user (SU) and the base station disposed in the area outside the service area corresponds to a base station of a primary user (PU), the height direction of each of the SU and the PU may be considered.

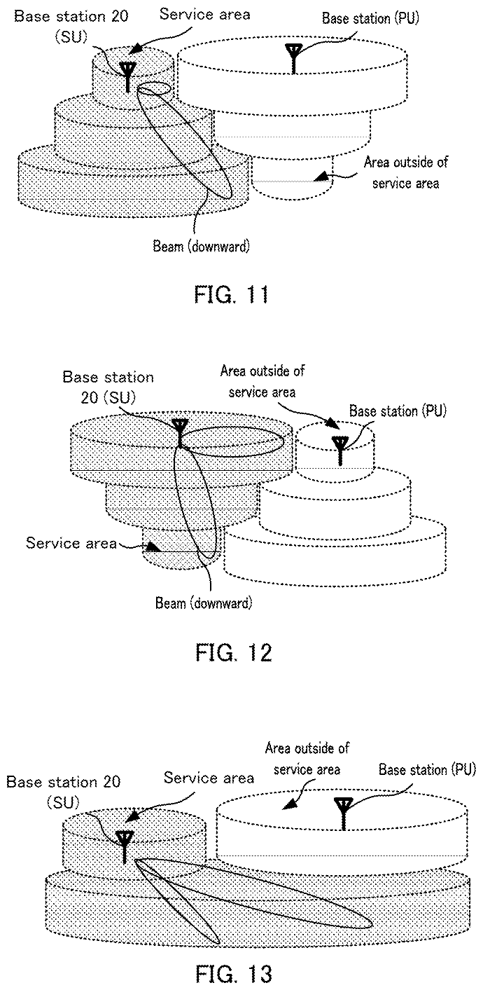

FIGS. 10 to 13 illustrate still another examples of the service area in the present embodiment.

For example, in FIGS. 10 to 13, the service area for the SU including the height direction and the area for the PU adjacent to the service area are illustrated.

In the case of FIGS. 10 to 13, base station 20 of the SU may form a beam that takes into account the height direction. For example, in the three-dimensional space defined by (X, Y, Z), when the (X, Y) coordinates are the same and the Z coordinates representing the height direction are different, it is possible to maintain allowable interference by using a beam suppressing the leakage power in consideration of the height direction, and the SU and the PU can coexist.

Note that, the above-described embodiment has been described in connection with the example in which one base station 20 is disposed in the service area, but the present disclosure is not limited thereto. For example, a plurality of base stations 20 may be disposed in the service area. In this case, the service area may be divided into respective radio wave reach ranges of the plurality of base stations 20. Then, each of base stations 20 may perform power control (beam control) to suppress the power leaking out of the radio wave reach range. Hereinafter, an example in which a plurality of base stations 20 are disposed will be described.

<Placement Example of Plurality of Base Stations 20>

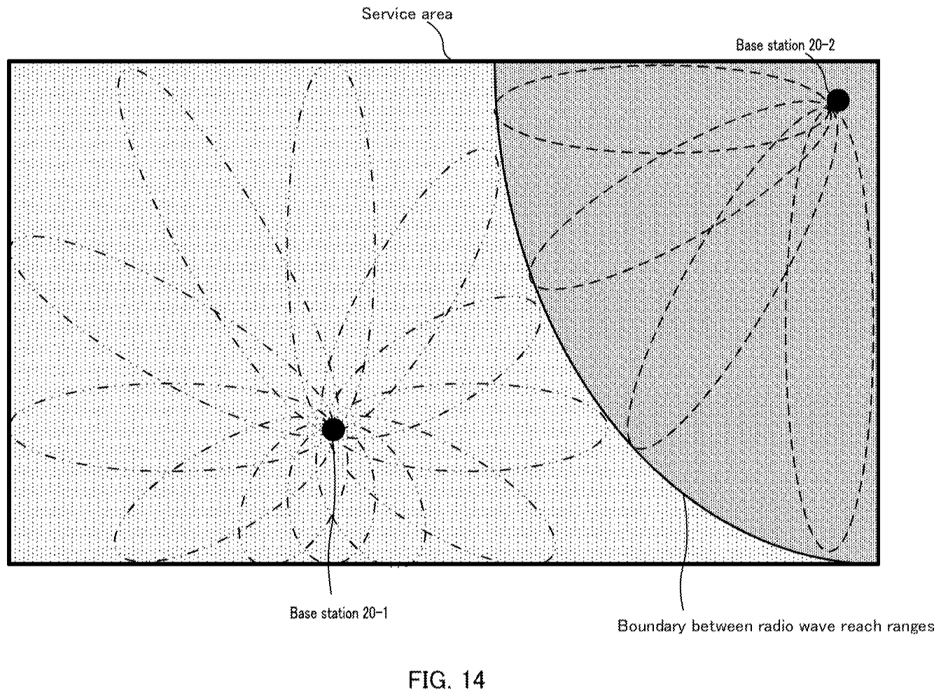

FIG. 14 illustrates one example in which a plurality of base stations 20 according to the present embodiment are disposed. In FIG. 14, two base stations 20 of base station 20-1 and base station 20-2 are located in the service area. Further, in FIG. 14, beams formed by base stations 20, the radio wave reach ranges, and a boundary between the radio wave reach ranges of two base stations 20 are illustrated.

As illustrated in FIG. 14, for example, when two base stations 20 are disposed in one service area, information processing apparatus 10 defines the boundary between the radio wave reach ranges of the base stations, and determines, for each of the two base stations 20, the beam control information for suppressing the power leaking out of the boundary.

Each base station 20 can reduce interference between base stations 20 by performing beam control based on the beam control information.

<Variation of Beam Control>

In the present embodiment, directivity obtained by combining a plurality of beams may be used in the beam control of base station 20.

For example, in some cases, base station 20 does not have spatial recognition processor 224, and/or an obstacle in the service area moves at such a high speed that the obstacle cannot be accurately recognized by spatial recognition processor 224. In such a case, base station 20 may, for example, form a beam with a directivity larger than the obstacle by combining a plurality of beams.

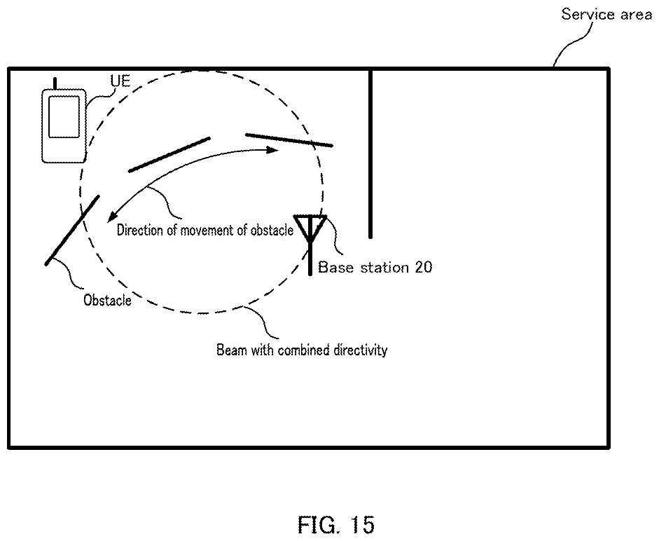

FIG. 15 illustrates one example of directivity control in the present embodiment. FIG. 15 illustrates base station 20, the UE, and the obstacle in the service area.

In FIG. 15, the obstacle periodically moves in the direction of movement illustrated. In this case, regarding the beam used for communication with the UE, base station 20 changes a beam with a narrow directivity to a beam with a directivity obtained by combining a plurality of beams.

This control can suppress the degradation of communication quality between base station 20 and the UE even when there is a movement of the obstacle.

Although the above embodiment has been described in connection with the radio communication between the base station and the UE as one example, the present disclosure is not limited to this. For example, the communication partner of the base station may be a radio device different from the UE. Alternatively, the present disclosure may be applied to communication between radio devices (communication apparatuses).

In the above embodiment, the terms “detection,” “recognition,” “estimation,” and “measurement” may be replaced with one another. Also, in the above embodiments, the terms “determination” and “selection” may be replaced with each other.

Note that the expression “section” used in the above-described embodiments may be replaced with another expression such as “circuit (circuitry),” “device,” “unit,” or “module.”

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

Various embodiments have been described with reference to the drawings hereinabove. Obviously, the present disclosure is not limited to these examples.

Obviously, a person skilled in the art would arrive variations and modification examples within a scope described in claims, and it is understood that these variations and modifications are within the technical scope of the present disclosure. Moreover, any combination of features of the above-mentioned embodiments may be made without departing from the spirit of the disclosure.

While concrete examples of the present invention have been described in detail above, those examples are mere examples and do not limit the scope of the appended claims. The techniques disclosed in the scope of the appended claims include various modifications and variations of the concrete examples exemplified above.

The disclosure of Japanese Patent Application No. 2020-006160, filed on Jan. 17, 2020, including the specification, drawings and abstract is incorporated herein by reference in its entirety.

### INDUSTRIAL APPLICABILITY

The present disclosure is suitable for radio communication systems.

### REFERENCE SIGNS LIST

10 Information processing apparatus
11 Storage
12 Calculation processor
20 Base station
21 Storage
22 Controller
23 Transmitter
24 Receiver
30 Spatial recognizer
221 Beam controller
222 Estimator
223 Recalculation processor
224 Spatial recognition processor

1. A base station, comprising:
control circuitry, which, in operation, controls a beam based on a simulation result regarding a radio propagation environment including radio wave propagation from an inside of an indoor area to an outside of the indoor area, the beam being to be formed in the indoor area; and
communication circuitry, which, in operation, communicates with a radio device using the beam.

2. The base station according to claim 1, wherein
the control circuitry determines the beam, the determining being not based on a report on reception quality at the radio device, the report being received by the communication circuitry from the radio device.

3. The base station according to claim 1, wherein
the control circuitry corrects transmission power of the radio device based on the simulation result, the transmission power being based on reception quality received from the radio device.

4. The base station according to claim 1, wherein
the control circuitry selects the beam based on a correspondence between one or more positions in the indoor area and a candidate for the beam, the correspondence being included in the simulation result, the beam being associated with a position of the radio device.

5. The base station according to claim 1, wherein
the control circuitry controls the beam based on detection information from a device that detects a change in the radio propagation environment in the indoor area.

6. An information processing apparatus, comprising:
a determiner, which, in operation, determines information on a beam to be formed by a base station in an indoor area where the base station is installed, the determining being based on a simulation result regarding a radio propagation environment including radio wave propagation from an inside of the indoor area to an outside of the indoor area; and
an output, which, in operation, outputs the determined information on the beam.

7. A radio communication method, comprising steps performed by a base station of:
controlling a beam based on a simulation result regarding a radio propagation environment including radio wave propagation from an inside of an indoor area to an outside of the indoor area, the beam being to be formed in the indoor area; and
communicating with a radio device using the beam.

8. A program that causes a computer to execute processing of:
determining a beam to be formed by a base station in an indoor area where the base station is installed, the determining being based on a simulation result regarding a radio propagation environment including radio wave propagation from an inside of the indoor area to an outside of the indoor area; and
outputting information on the beam determined.
